(19) United States
(12) Patent Application Publication
(10) Pub. No.: US 2022/0399149 A1
(43) Pub. Date: Dec. 15, 2022

(54) Magnetic Core Assembly And Manufacturing Process Thereof

(71) Applicants: Permanent Magnets Limited, Thane (IN); Maglab Limited, Basel (CH)

(72) Inventors: Sharad Taparia, Mumbai (IN); Peter Krummenacher, Basel (CH)

(21) Appl. No.: 17/755,792

(22) PCT Filed: Nov. 28, 2020
(86) PCT No.: PCT/IN2020/050988

§ 371 Date: May 29, 2022

(30) Foreign Application Priority Data
Dec. 18, 2019 (IN) 201921052501

(51) Int. Cl. H01F 27/24; H01F 41/02

(52) U.S. Cl. CPC H01F 27/24; H01F 41/0206

(57) ABSTRACT

Optimum magnetic core assembly (100) and manufacturing process thereof comprising a primary magnetic alloy (101) and at least one supplementing magnetic alloy (102), made of a magnetic material (90) pre-coated with an electrically insulating layer (90C); the optimum open magnetic core assembly (100) has a pair of ends of a laminated magnetic core (110), each of the pair of ends of the optimum magnetic core assembly (100) being one of a co-facing (111) and a flat (113), or a co-facing (111) and a contoured (114), or a co-planer (112) and a flat (113), or a co-planer (112) and a contoured (114); a process of producing is one of a wrapping based process ONE (30) or a stamping based process TWO (40) followed by a magnetic performance treatment (50); the optimum magnetic core (100) is a hybrid core wherein the laminations are grouped and or interlaced laminations (70).

### CLAIM OF PRIORITY

This application claims priority to Indian Provisional Patent Application no. 201921052501 filed on Dec. 18, 2019, titled “OPTIMUM MAGNETIC CORE ASSEMBLY AND MANUFACTURING PROCESS THEREOF”.

### FIELD OF INVENTION

The present invention relates to magnetic cores and particularly to magnetic cores used for current measurement. More particularly, the present invention relates to high efficiency magnetic cores for compact applications.

### BACKGROUND

Use of magnetic cores for current measurement is known, wherein a magnetic field generated by a current to be measured is made to produce energy in direct proportion and such energy is measured. Such a concept to measure the current indirectly has several benefits to be able to electrically isolate such a measurement, to be able to measure a large current, et cetera.

It is known that there are transformation errors in such indirect measurement. Saturation of magnetic cores, errors due to pilferage of magnetic field, effect of other magnetic fields in the vicinity are some of the challenges. Further, lost energies in any energy conversion results into generation of heat energy and consequent unwanted temperature rise.

BE1002498A6 discloses a manufacturing process of a magnetic core using a continuous metal ribbon. CN103475170B, U.S. Pat. No. 8,048,509B2 and CN1439163A discloses methods to manufacture magnetic cores using stampings.

Further, different industrial applications require tailor-made solutions which however become costly due to higher custom tooling and or manufacturing costs. JP2015050290A discloses a hybrid magnetic core loaded power inductor for high frequency application, wherein the hybrid magnetic core loaded power inductor includes a substrate, a first magnetic layer formed on the substrate, a conductive pattern formed on the first magnetic layer, at least an upper surface of the conductive pattern and a second magnetic layer.

It is well understood that while laminations or multiple layering is an indispensable step in making a magnetic core, the related manufacturing issues continue to pose challenge in mass producing magnetic cores with optimum and consistent magnetic behavior.

Present invention addresses such industrial need effectively and economically.

### OBJECTIVES

To invent a magnetic core assembly that efficiently manages a high magnetic field.

To invent a magnetic core assembly suitable for a wide range of current.

To invent a magnetic core assembly that has minimized eddy currents.

To invent a magnetic core assembly that is designed for prescribed disposal in an enclosure or molding for consistent output.

To invent a magnetic core assembly that is stable and suitable for operation at electric current ranging from direct current to high frequency current, of the order of 50,000 Hz.

To invent a magnetic core assembly that is constructionally conducive for deploying in over-molding and or insert molding.

To invent a magnetic core assembly that is inventively designed for mass manufacturing/assembly and or automation.

To invent a magnetic core assembly deployable in automobile products with product life of the order of more than 15 years.

To invent a magnetic core assembly that has minimal material wastage as scrap.

To invent a magnetic core assembly that is usable as a shield or a flux concentrator.

To invent a process to achieve above objectives.

### SUMMARY OF INVENTION

The present invention is an optimum open magnetic core assembly which is optimized for a pair of ends of a laminated magnetic core. The pair of ends of the laminated core are either co-facing or co-planer, and either flat or contoured. The term contoured pair of ends includes the pair of ends with multiple flats as well. It is known that magnetic linkage in an open magnetic core interacts with a sensor positioned or protected in-between the pair of ends and thus construction of the pair of ends is of significant importance for most of the objectives outlined above.

The optimum open magnetic core assembly comprises a primary magnetic alloy and one or more supplementing magnetic alloy with a co-facing and flat pair of ends, or a co-facing and contoured pair of ends, or a co-planner and flat pair of ends, or a co-planer and contoured pair of ends. The optimum open core assembly has a stacking factor of 96 to 99%.

A thin sheet of the optimum resistivity which meets magnetic requirement is selected. The embodiments described here are with a 0.2 mm thin sheet of 48% NiFe as the primary magnetic alloy. 0.2 mm thin sheet of SiFe is used as the supplementing magnetic alloy. These sheets have an initial hardness of 420 to 480 HV (on Vickers scale). A combination of lower thickness and higher hardness facilitates producing burr free machining including slitting and shearing as per present invention, which minimizes eddy currents.

An Application inputs and a Level ONE of specification as derived above and including
a magnetic material,
a lamination thickness,
a hardness,
a lamination shape based on sensor and precision,
a shape of pole, and
a core dimensions
   leads to a selection of a Process ONE or a Process TWO, followed by a magnetic performance enhancement treatment.

The magnetic materials are pre-coated with an electrically insulating layer. The electrically insulating layer has a “flowing property” that is, the electrically insulating layer flows onto a sheared edge and a sheared surface of the magnetic material such that a 50 to 100 percent of the sheared edge and the sheared surface still remains covered with the electrical insulating layer.

A process ONE of producing the optimum magnetic core assembly with a co-planer and flat pair of ends, or with a co-facing and flat pair of ends, is by a wrapping method.

It is well known that use of laminations introduces an unwanted air gaps in-between laminations adversely affecting magnetic permeability of the core. The air gap is effectively reduced as follows:

A start edge entrapment wherein the start edge of a roll of a sheet of the magnetic material of the primary magnetic alloy is folded and lockingly engaged with a slot in a mandrel.

To achieve a target stacking factor, the sheet of the magnetic material is kept pulled by a tensile force Ft while the mandrel is rotated. The tensile force Ft is significantly lower than and is commensurate with a tensile strength of the sheet. Additionally, a compressive force Fc is applied intermittently by momentarily stopping the mandrel in an orthogonal plane.

On achieving a requisite width of thus wound core, the sheet is slit, and a last edge of the sheet thus created is permanently disposed on the wound core, preferably by multiple spot welding (not shown). When such wound core is dismounted from the mandrel an arch is generally observed all around. A correction fixture comprising an inserter and a casing is deployed and by this process of an arch correction is obtained a corrected wound core of the primary magnetic alloy.

Following exactly the same steps, a corrected wound core of the supplementing magnetic alloy is produced, an external width and an external height of the corrected wound core of the supplementing magnetic alloy tends to be equal to an internal width and an internal height of the corrected core of the primary magnetic alloy. The corrected wound core of the supplementing magnetic alloy is interferingly inserted in the corrected wound core of the primary magnetic alloy to arrive at a hybrid corrected core.

The hybrid corrected core is slotted and then sliced to obtain a bare optimum magnetic core assembly, that is encased in a non-magnetic resin or a non-magnetic engineering plastic body, after a magnetic enhancement treatment.

As a variation, a start edge of a roll of a sheet of a selected magnetic material of the primary/supplementary magnetic alloy is provided with a plurality of orifices, and each orifice is engaged with a spring-loaded pin with a spring disposed in a second mandrel. To dismount the such wound core from the second mandrel, the spring-loaded pins are pulled back to free the such wound core.

A process TWO of producing the optimum open magnetic core assembly with a co-facing and contoured pair of ends, or with a co-planer and a contoured face, is now described. The preferred embodiment is produced by a stamping method. The stamping method is deployed so as to produce magnetic core with a contour specific to a sensor device with most optimum and desired magnetic linkage, providing liberal radii and avoiding sharp corners, since the previously described wrapping process produces optimum cores which are flat faced with sharp ends.

A custom-built punching tool is deployed to produce a required number of primary stampings of the primary magnetic alloy and a required number of supplementary stampings of the supplementing magnetic alloy, which are then stacked together. The primary stampings and the supplementary stampings are compressed and inseparably get attached to one another through a joining means provided on each stamping. Thus, is obtained a bare magnetic core.

The joining means in a preferred embodiment is a plurality of partially displaced projections. The electrically insulating layer on the primary stampings and the supplementary stampings “flows” in a direction of a travel of a shearing tool and keeps the new edges/new exposed surfaces still covered. The joining means may be an aperture to be engaged with a rivet or a molten metal.

The bare magnetic core that is encased in a case and a cover in a non-magnetic resin or a non-magnetic engineering plastic body, after the magnetic enhancement treatment produces the optimum magnetic core assembly.

The required number of primary stampings of the primary magnetic alloy and the supplementary stampings of the supplementing magnetic alloy are stacked either in a single group of each or multiple groups. Most optimum magnetic properties are obtained by an interlaced laminations, alternating the primary stampings and the supplementary stampings, i.e. one each of primary stamping and supplementary stamping alternately; or any alternate combination thereof.

Such interlacing is obtainable either by the process ONE and or the process TWO equally effectively, though finer interlacing is a manufacturing challenge for the process ONE.

The stampings are compressed and inseparably get attached to one another through the means provided on each stamping. Required magnetic behavior is obtainable by an optimum combination of material, dimensions and contour of face, and stacking pattern/interlaced laminations.

Before encasing the bare optimum magnetic core, the magnetic enhancement treatment carried out comprises the following:

Grain growth: Oxygen free annealing results in grain grown of magnetic material, without causing deterioration in terms of induced rusting. As per the present invention, the oxygen free annealing is done in a hydrogen environment. The bare optimum magnetic cores are elevated to a soaking temperature of 1120 to 1180° C. for 4 to 6 hours and then allowed to cool to a room temperature, all in the hydrogen atmosphere. Such a combination of temperature, duration and hydrogen presence also results in removal of grain growth inhibitors like Carbon, Sulphur, etc., to ensure optimal enhancement of magnetic properties. During the annealing process, the grains are refined to remove grain growth inhibitors, the grain boundaries merge to increase the grain size and stresses are removed. Since grain boundaries are not having crystalline structure, they do not have any magnetic properties. So, having few and thin boundaries is good for magnetic properties. If there is excessive growth, then the grain boundaries tend to become thick, which would be detrimental since oversize grains can have eddy current losses at high frequencies and the thick boundaries are block the magnetic path. A retort Atmosphere Control therefore becomes an important quality control challenge. Presence of Carbon, Sulphur, Chlorine, Oxygen or any extraneous material is detrimental for the grain growth. The retort door is carefully clamped with Silicon rubber seals to ensure no leakage of air inside the retort. After clamping the retort, the retort is checked for leakage test to ensure there are no leakages in the retort and input gas lines. Gas flow rate is controlled to get 5 volume changes per hour. For maintaining input gas purity throughout the length of the furnace, Hydrogen gas input lines extending from back of retort to the front with designed holes are used. To achieve Cpk of min 1.33 for magnetic properties, the retort temperature uniformity is maintained within +/−12° C. Pre-Soaking at annealing is done for 1 hour to ensure parts in different zones of retort reach the same temperature. Temperature is raised at 150° C./hour. Any stress on the part after annealing, results in deterioration of magnetic properties. Cooling rate is maintained at a specified rate preferably 100° C.-150° C./hr. The retort is opened at a specified temperature, preferably 100° C. to ensure that parts and retort do not get oxidized on exposure to air.

Vacuum varnish Impregnation and baking is carried out to prevent a tendency of laminations to separate with time, and therefore for bonding the layers with one another, also for further insulating the layers by exploiting air gaps. The bare magnetic core preheated at 100° C., varnish impregnation process is then carried out at 3 to 4 mbar pressure for 20 minutes, followed by curing at 120° C./1 hr. followed by post-curing at 180° C. for 1-2 hours. The process causes a varnish layer to occupy the erstwhile air gap.

To provide an optional resin coating, the bare magnetic core is preheated at 250° C. for 20 min, then immersed in vibrating resin powder, for a prescribed time that depends on a desired thickness of coating and size of the bare magnetic core. The core is thereafter naturally air cooled.

### DESCRIPTION OF DRAWINGS

FIG. 1 is a perspective view of an optimum magnetic core assembly as per present invention, while FIG. 1A is a perspective view of deployment of such magnetic core assembly.

FIG. 2 is a perspective views of different kinds of pair of ends of the optimum magnetic core assembly.

FIG. 3 is a sectional view of a sheared face of a magnetic material.

FIG. 3A-3C is a flow diagram of a process of manufacturing the optimum magnetic core assembly as per the present invention.

FIG. 4 is a partial front view of a stack of laminations.

FIGS. 5, 9 and 10 are a stage diagram of a process ONE.

FIG. 6 is a representative cross sectional view of a wound core.

FIG. 7 is a perspective and a side view of an insertor of a correction fixture while

FIG. 8 is a perspective view of the correction fixture in use.

FIG. 11A-11B, 12-12A are stage diagrams of a process TWO.

FIG. 13 shows a pre-annealing hysteresis curve and a post-annealing improved hysteresis curve of a magnetic core.

FIGS. 14 and 15 is a side view of laminations showing air gaps and varnish layers.

FIG. 16 is a perspective view of encasing components.

FIG. 17 shows an interlacing laminations.

FIG. 17A-17D are a representative diagrams of magnetic lines of forces with grouped and interlaced laminations at low and high currents.

### DETAILED DESCRIPTION

The present invention shall now be described with the help of accompanying drawings. It is to be expressly understood that there are several variations and embodiments producible as per present invention and the description and any part thereof is not to be construed to limit the invention thereto.

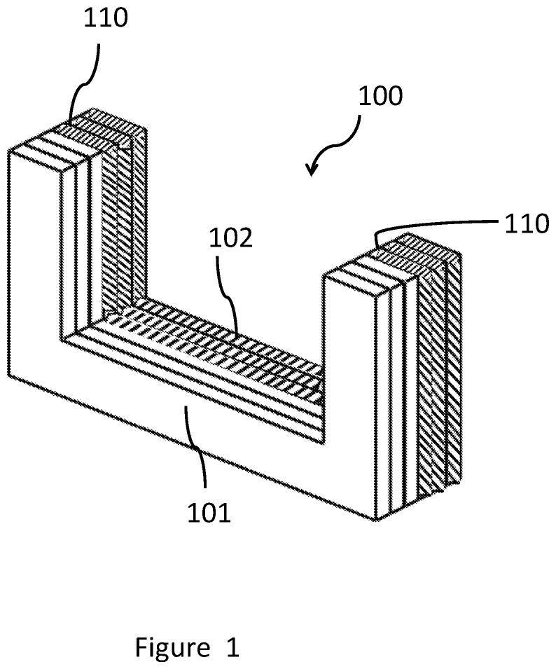

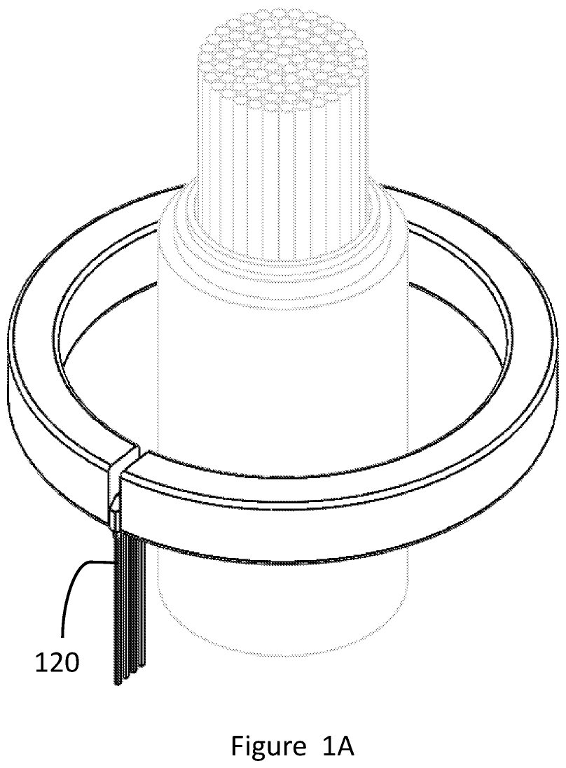

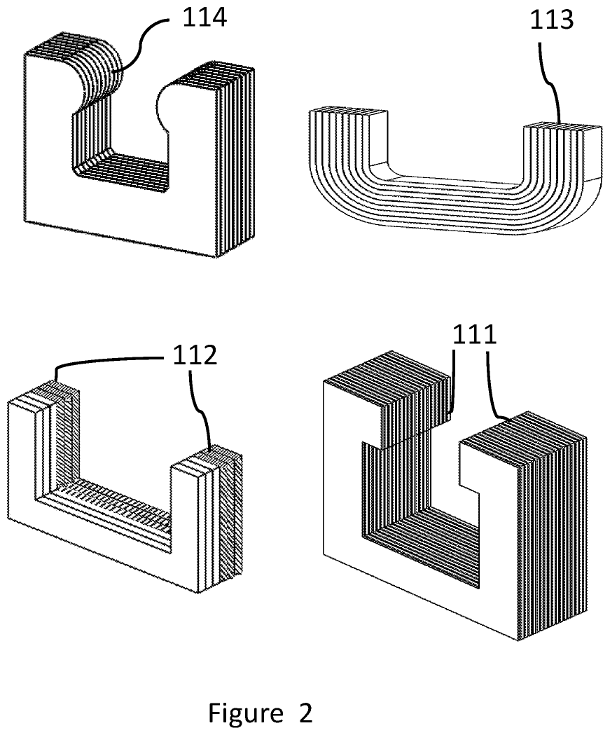

FIG. 1, 1A, 2, the present invention is an optimum open magnetic core assembly (100) which is optimized for a pair of ends of a laminated magnetic core (110). The pair of ends of the laminated core (110) are either co-facing (111) or co-planer (112). Further, the pair of ends of the laminated core (110) of the optimized magnetic core assembly (100) as per present invention are either flat (113) or contoured (114). The term contoured pair of ends (114) includes the pair of ends with multiple flats as well. It is known that magnetic linkage in an open magnetic core interacts with a sensor (120) positioned or protected in-between the pair of ends and thus construction of the pair of ends is of significant importance for most of the objectives outlined above.

The present invention is an optimum open magnetic core assembly (100) comprising of a primary magnetic alloy (101) and one or more supplementing magnetic alloy (102) with a co-facing (111) and flat (113) pair of ends, or a co-facing (111) and contoured (114) pair of ends, or a co-planner(112) and flat (113) pair of ends, or a co-planer (112) and contoured (114) pair of ends. The optimum open core assembly (100) has a stacking factor of 96 to 99%. The stacking factor, also known as the lamination factor, is the ratio of effective cross section to the physical cross section and indicates cumulative air gaps introduced in any core assembly.

It is known that eddy current is a necessary evil byproduct of a varying magnetic field causing energy loss in accordance with the equation

E=f(d²/ρ)
Where E=Energy loss
d=thickness of sheet
ρ=resistivity of material of sheet

Consequently, a thin sheet of the optimum resistivity which meets magnetic requirement is selected. The embodiments described here are with a 0.2 mm thin sheet of 48% NiFe as the primary magnetic alloy (101). 0.2 mm thin sheet of SiFe is used as the supplementing magnetic alloy (102). These sheets have an initial hardness of 420 to 480 HV (on Vickers scale). A combination of lower thickness and higher hardness facilitates producing burr free machining including slitting and shearing as per present invention, which minimizes eddy currents.

An Application inputs (10) and a Level ONE (20) of specification as derived above and including
a magnetic material,
a lamination thickness,
a hardness,
a lamination shape based on sensor and precision,
a shape of pole, and
a core dimensions
   leads to a selection of a Process ONE (30) or a Process TWO (40), followed by a magnetic performance enhancement treatment (50) to obtain the optimum open magnetic core assembly (100) as per the present invention.

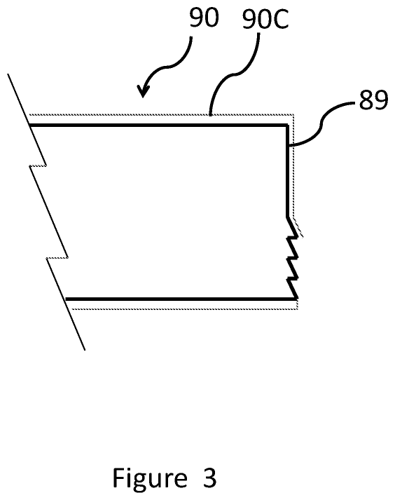

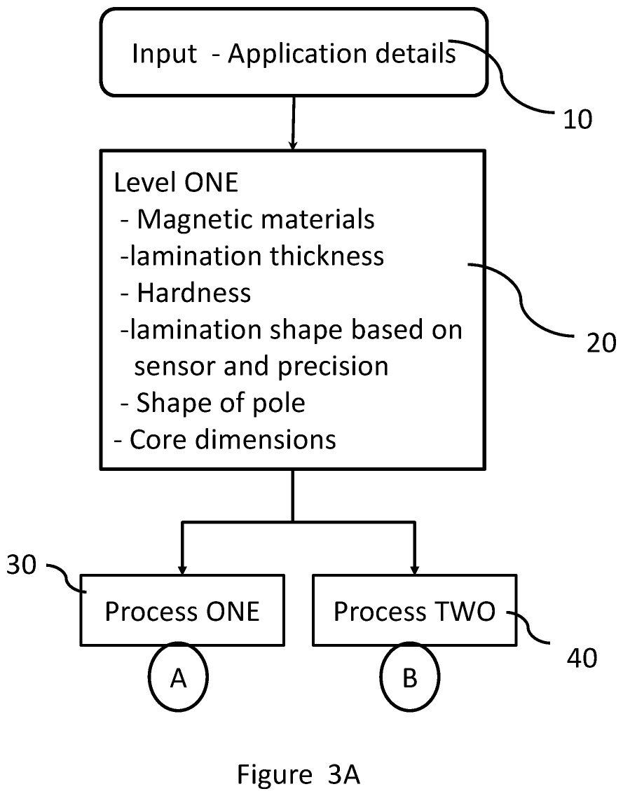

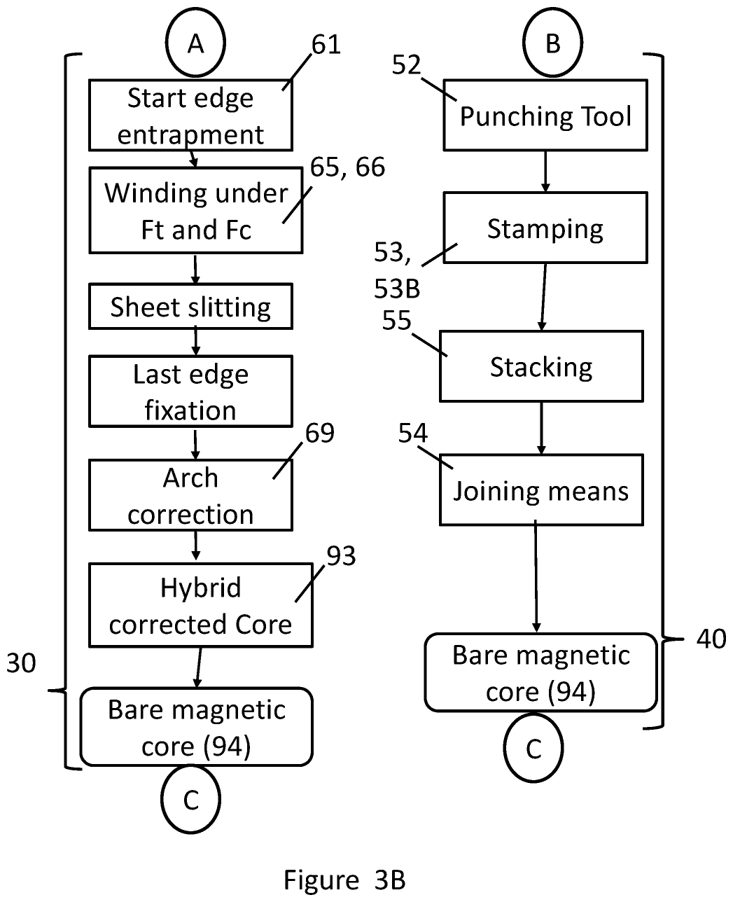

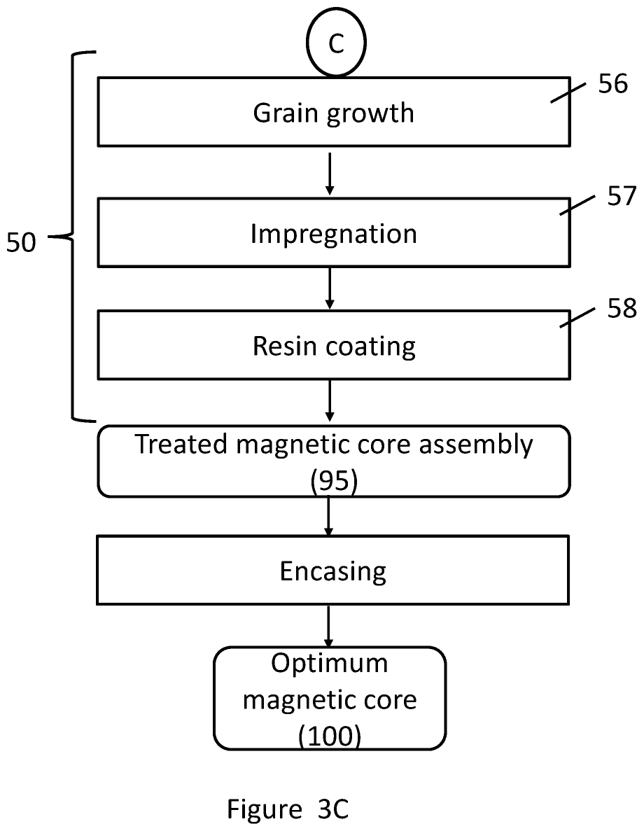

FIG. 3, the magnetic materials (90) are pre-coated with an electrically insulating layer (90C). The electrically insulating layer (90C) has a “flowing property” that is, the electrically insulating layer (90C) flows onto a sheared edge and a sheared surface (89) of the magnetic material (90) such that a 50 to 100 percent of the sheared edge and the sheared surface (89) still remains covered with the electrical insulating layer (90C).

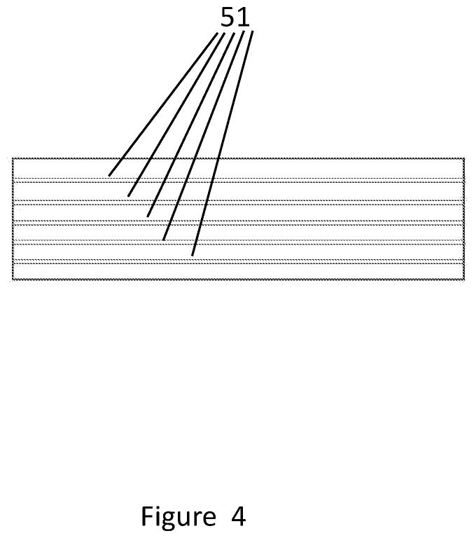

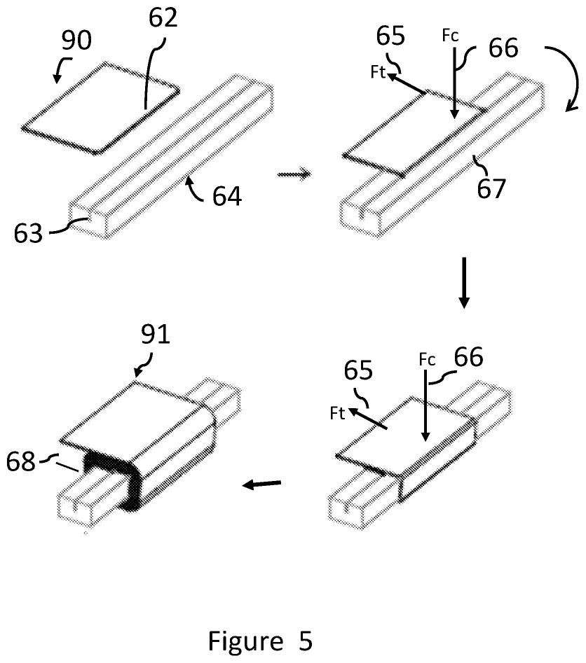

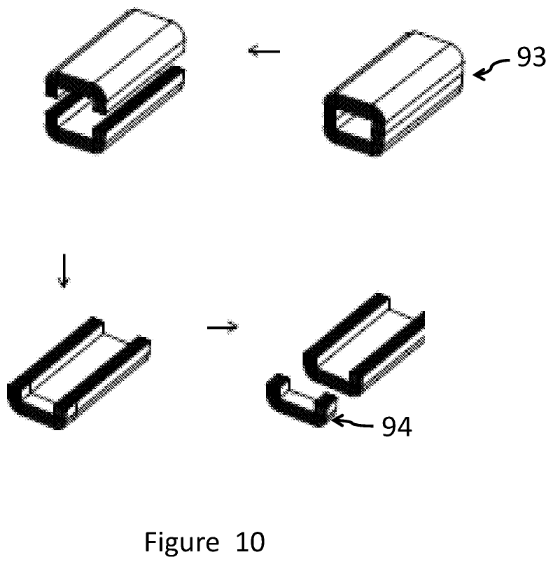

A process ONE (30) of producing the optimum magnetic core assembly (100) with a co-planer and flat pair of ends, or with a co-facing and flat pair of ends, is by a wrapping method. FIGS. 3A-3C, 4-10, and 11A-11B. In this process there is minimal or no material wastage.

It is well known that use of laminations introduces an unwanted air gaps (51) in-between laminations adversely affecting magnetic permeability of the core. The air gap is effectively reduced as follows:

A start edge entrapment (61) wherein the start edge (62) of a roll of a sheet of the magnetic material (90) of the primary magnetic alloy (101) is folded and lockingly engaged with a slot (63) in a mandrel (64).

To achieve a target stacking factor, the sheet of the magnetic material (90) is kept pulled by a tensile force Ft (65) while the mandrel (64) is rotated. The tensile force Ft (65) is significantly lower than and is commensurate with a tensile strength of the sheet. Additionally, a compressive force Fc (66) is applied intermittently by momentarily stopping the mandrel (64) in an orthogonal plane (67).

On achieving a requisite width (68) of thus wound core (91), the sheet is slit, and a last edge of the sheet thus created is permanently disposed on the wound core (91) , preferably by multiple spot welding (not shown).

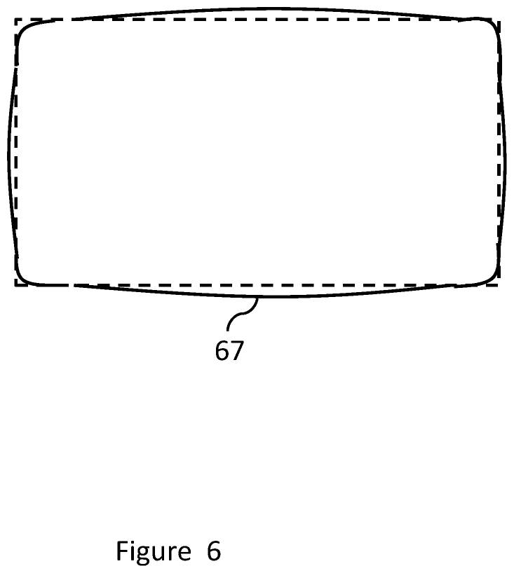

When such wound core (91) is dismounted from the mandrel an arch (67) is generally observed all around, FIG. 6.

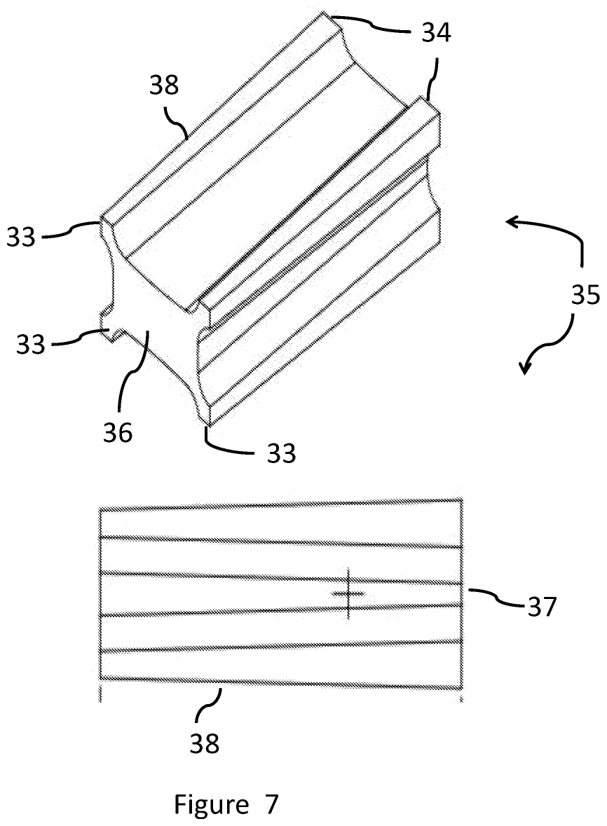

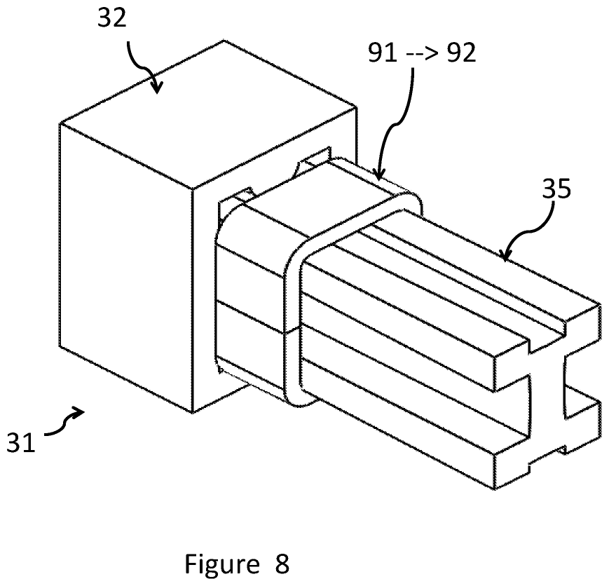

FIGS. 7 and 8, a correction fixture (31) comprising an inserter (35) and a casing (32) is deployed. The inserter (35) has four entry corners (33) of an entry side face (36) and four exit corners (34) of an exit face (37). The entry face (36) is smaller than the exit face (37). The entry corners (33) and the exit corners (34) are connected through a prismatic frustum (38). The wound core (91) is made to pass through the correction fixture (31). Thus, by this process of an arch correction (69) is obtained a corrected wound core (92) of the primary magnetic alloy (101).

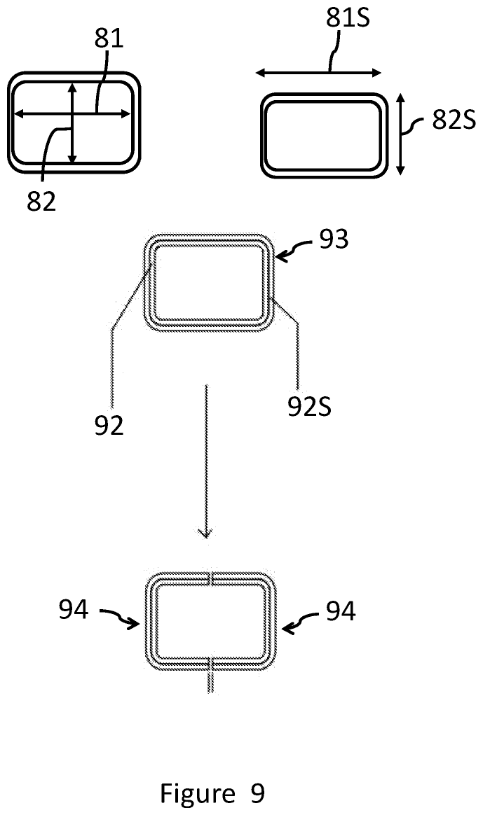

Following exactly the same steps, a corrected wound core (92S) of the supplementing magnetic alloy (102) is produced, an external width (81S) and an external height (82S) of the corrected wound core (92S) of the supplementing magnetic alloy tends to be equal to an internal width (81) and an internal height (82) of the corrected core (92) of the primary magnetic alloy (101). The corrected wound core (92S) of the supplementing magnetic alloy (102) is interferingly inserted in the corrected wound core (92) of the primary magnetic alloy (101) to arrive at a hybrid corrected core (93). FIG. 9

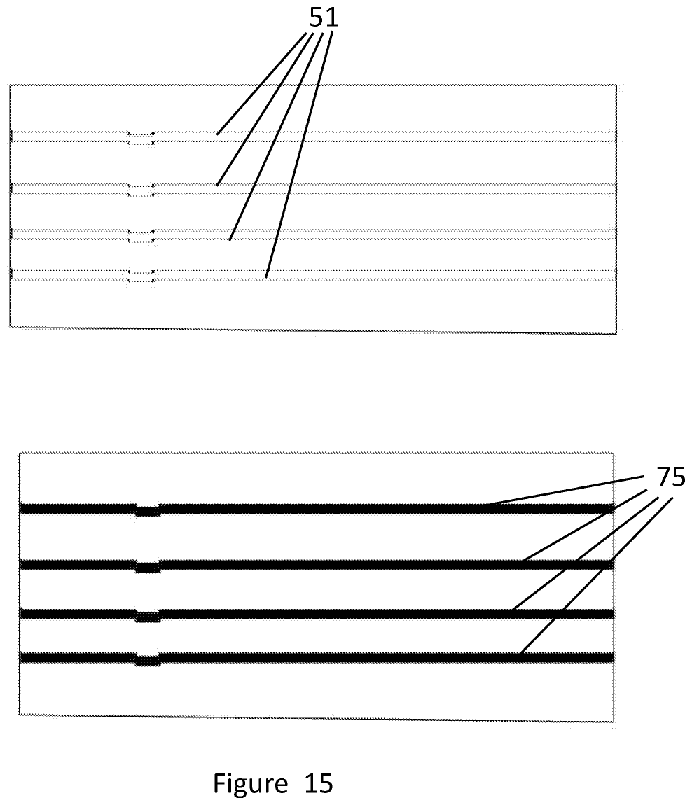

The hybrid corrected core (93) is slotted and then sliced to obtain a bare magnetic core assembly (94), that is encased in a non-magnetic resin or a non-magnetic engineering plastic body (FIG. 15), after a magnetic enhancement treatment (50).

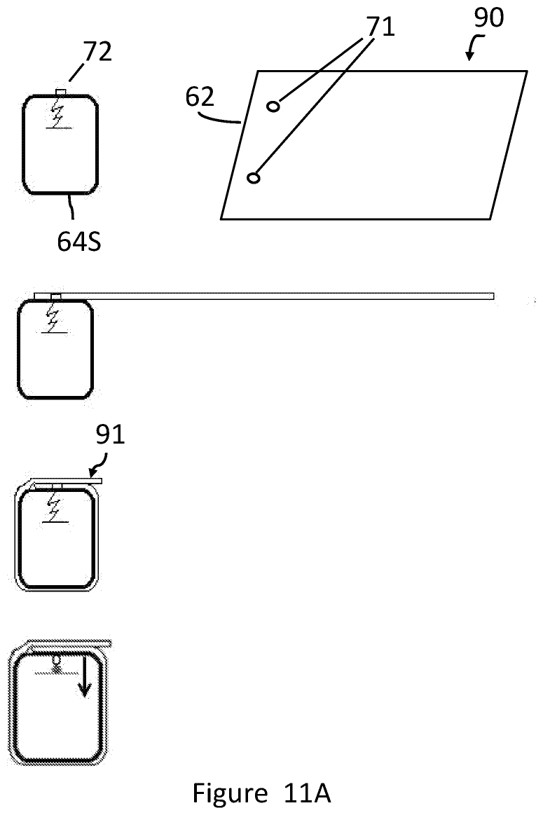

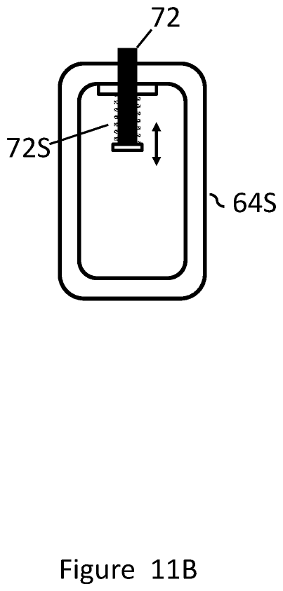

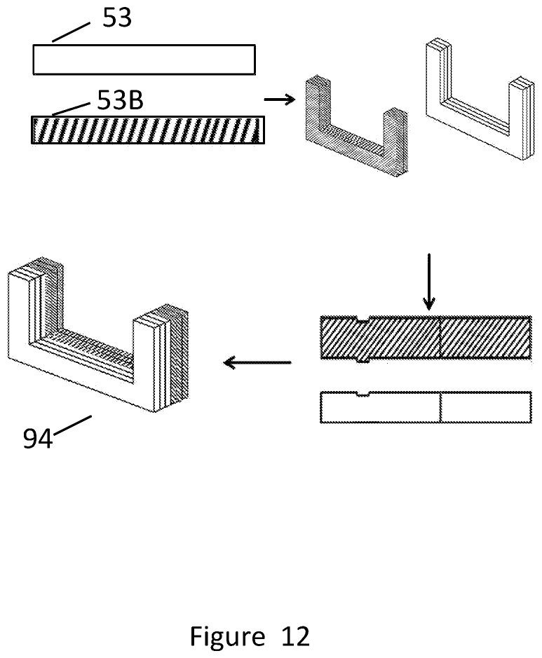

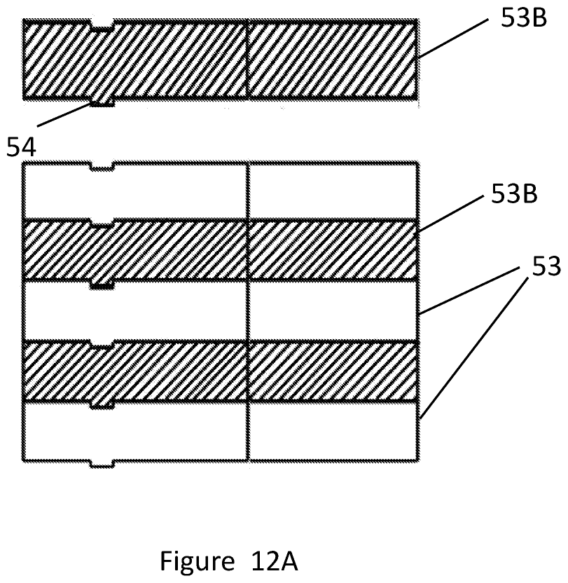

FIG. 11A-11B, as a variation, a start edge (62) of a roll of a sheet of a selected magnetic material (90) of the primary/supplementary magnetic alloy (101/102) is provided with a plurality of orifices (71), and each orifice is engaged with a spring-loaded pin (72) with a spring (72S) disposed in a second mandrel (64S). To dismount the such wound core (91) from the second mandrel (64S), the spring-loaded pins (72) are pulled back to free the such wound core (91).

FIG. 3A-3C, 12, 12A, a process TWO (40) of producing the optimum open magnetic core assembly (100) with a co-facing (111) and contoured (114) pair of ends, or with a co-planer (112) and a contoured (114) face, is now described here below. The preferred embodiment is produced by a stamping method. The stamping method is deployed so as to produce magnetic core with a contour specific to a sensor device with most optimum and desired magnetic linkage, providing liberal radii and avoiding sharp corners, since the previously described wrapping process produces optimum cores which are flat faced with sharp ends.

A custom-built punching tool (52) is deployed to produce a required number of primary stampings (53) of the primary magnetic alloy (101) and a required number of supplementary stampings (53B) of the supplementing magnetic alloy (102), which are then stacked (55) together. The primary stampings (53) and the supplementary stampings (53B) are compressed and inseparably get attached to one another through a joining means provided on each stamping. Thus, is obtained a bare magnetic core (94).

The joining means in a preferred embodiment is a plurality of partially displaced projections (54). The electrically insulating layer (90C) on the primary stampings (53) and the supplementary stampings (53B) “flows” in a direction of a travel of a shearing tool and keeps the new edges/new exposed surfaces (89) still covered. The means may be an aperture to be engaged with a rivet or a molten metal.

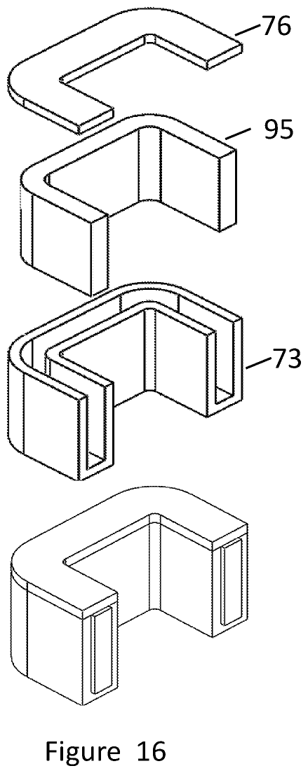

The bare magnetic core (94) is encased in a case (73) and a cover (76) in a non-magnetic resin or a non-magnetic engineering plastic body (FIG. 16), after the magnetic enhancement treatment (50) produces the optimum magnetic core assembly (100) as per present invention.

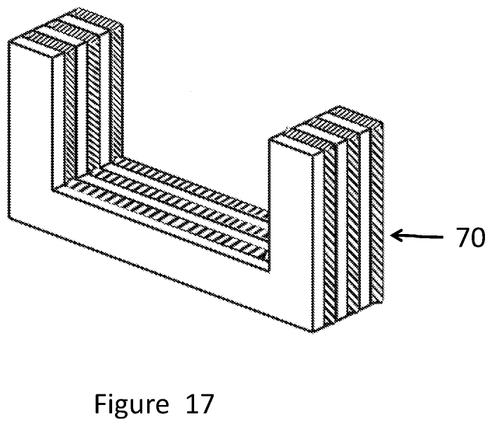

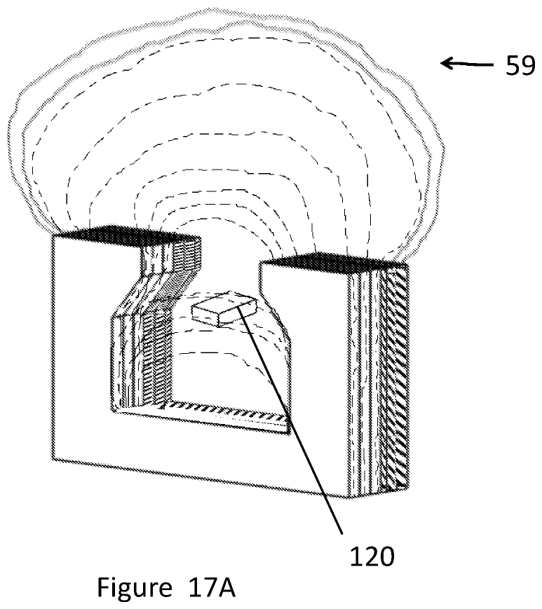

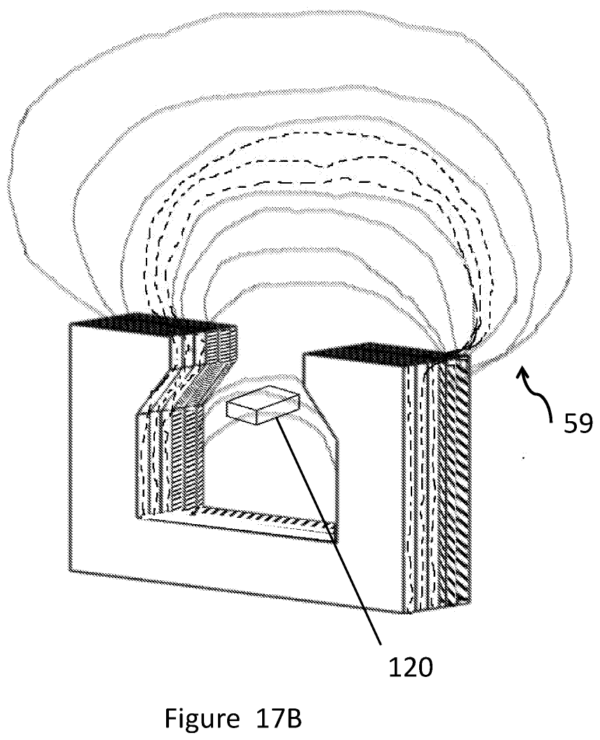

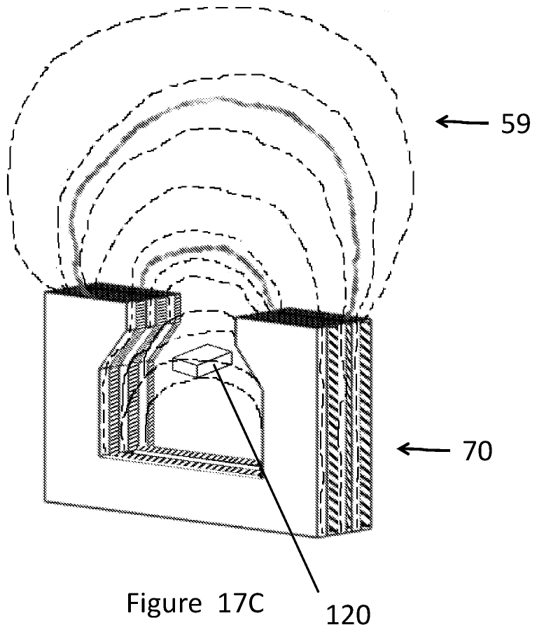

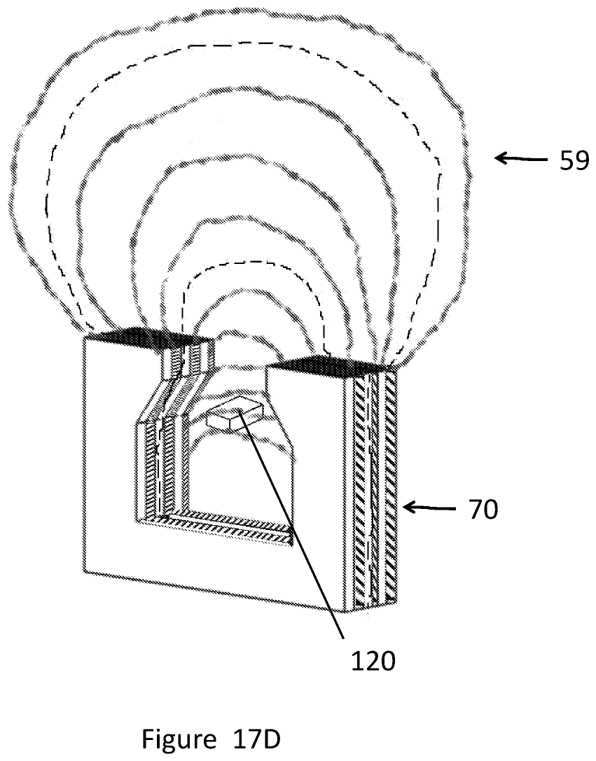

The required number of primary stampings (53) of the primary magnetic alloy (101) and the supplementary stampings (53B) of the supplementing magnetic alloy (102) are stacked either in a single group of each or multiple groups. Most optimum magnetic properties are obtained by an interlaced laminations (70) alternating the primary stampings (53) and the supplementary stampings (53B), FIG. 17, i.e. one each of primary stamping (53) and supplementary stamping (53B) alternately; or any alternate combination thereof. FIG. 17A-17D amply illustrate the comparative benefit wherein FIGS. 17A and 17B have the primary stampings (53) and supplementary stampings (53B) grouped while FIGS. 17C and 17D have the primary stampings (53) and the supplementary stampings (53B) interlaced. FIGS. 17A and 17C illustratively map a magnetic field (59) of low current, 100 mA to 10 A while FIGS. 17B and 17D map the magnetic field (59) of a high current, 10 A to 1000 A. Persons skilled in the art are well aware of magnetic behavior of NiFe as a high permeability magnetic material, and also of SiFe as a relatively lower permeability magnetic material. FIGS. 17C and 17D clearly bring out their combinational behavior in the interlaced lamination (70) over a current range as wide as 10 mA to 1000 A, with reference to their combinational behavior in grouped laminations as shown in FIGS. 17A and 17B, and their previously known individual magnetic behavior. The interlaced laminations (70) result in a more uniform magnetic field distribution, represented by a plurality of magnetic lines of forces in two different line types; and this is the essence of the present invention, because any variation in a position of the sensor (120) does NOT result in a measurement and or shielding variation.

Such interlacing is obtainable either by the process ONE (30) and or the process TWO (40) equally effectively, though finer interlacing is a manufacturing challenge for the process ONE (30).

The stampings (53, 53B) are compressed and inseparably get attached to one another through the means provided on each stamping (53, 53B). Required magnetic behavior is obtainable by an optimum combination of material, dimensions and contour of face, and stacking pattern/interlaced laminations (70).

Before encasing (FIG. 16) the bare magnetic core (94), the magnetic enhancement treatment (50) carried out comprises the following:

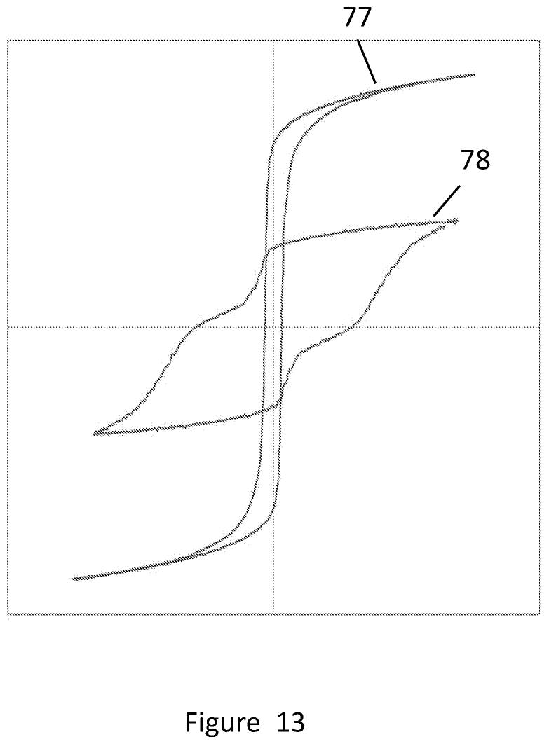

Grain growth (56): Oxygen free annealing results in grain grown of magnetic material, without causing deterioration in terms of induced rusting. As per the present invention, the oxygen free annealing is done in a hydrogen environment. The bare optimum magnetic cores are elevated to a soaking temperature of 1120 to 1180° C. for 4 to 6 hours and then allowed to cool to a room temperature, all in the hydrogen atmosphere. Such a combination of temperature, duration and hydrogen presence also results in removal of grain growth inhibitors like Carbon, Sulphur, etc., to ensure optimal enhancement of magnetic properties. During the annealing process, the grains are refined to remove grain growth inhibitors, the grain boundaries merge to increase the grain size and stresses are removed. Since grain boundaries are not having crystalline structure, they do not have any magnetic properties. So, having few and thin boundaries is good for magnetic properties. If there is excessive growth, then the grain boundaries tend to become thick, which would be detrimental since oversize grains can have eddy current losses at high frequencies and the thick boundaries are block the magnetic path. A retort Atmosphere Control therefore becomes an important quality control challenge. Presence of Carbon, Sulphur, Chlorine, Oxygen or any extraneous material is detrimental for the grain growth. The retort door is carefully clamped with Silicon rubber seals to ensure no leakage of air inside the retort. After clamping the retort, the retort is checked for leakage test to ensure there are no leakages in the retort and input gas lines. Gas flow rate is controlled to get 5 volume changes per hour. For maintaining input gas purity throughout the length of the furnace, Hydrogen gas input lines extending from back of retort to the front with designed holes are used. To achieve Cpk of min 1.33 for magnetic properties, the retort temperature uniformity is maintained within +/−12° C. Pre-Soaking at annealing is done for 1 hour to ensure parts in different zones of retort reach the same temperature. Temperature is raised at 150° C./hour. Any stress on the part after annealing, results in deterioration of magnetic properties. Cooling rate is maintained at a specified rate preferably 100° C.-150° C./hr. The retort is opened at a specified temperature, preferably 100° C. to ensure that parts and retort do not get oxidized on exposure to air. FIG. 13 shows a pre-annealing hysteresis curve (77) and a post-annealing improved hysteresis curve (78).

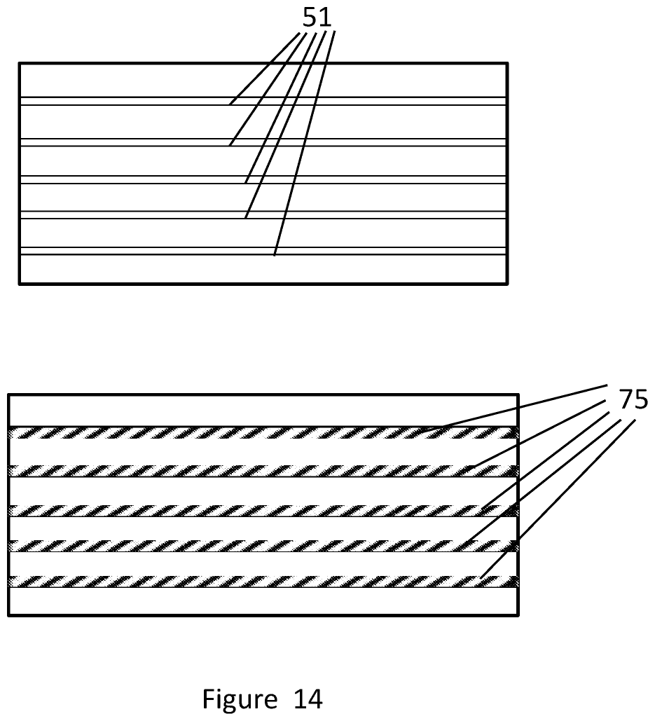

Vacuum varnish Impregnation and baking (57) is carried out to prevent a tendency of laminations to separate with time, and therefore for bonding the layers with one another, also for further insulating the layers by exploiting air gaps. The bare magnetic core preheated at 100° C., varnish impregnation process is then carried out at 3 to 4 mbar pressure for 20 minutes, followed by curing 'at 120° C./1 hr followed by post-curing at 180° C. for 1-2 hours. The process causes a varnish layer (75) to occupy the erstwhile air gap (74), FIGS. 14, 15.

To provide an optional resin coating (58), the bare magnetic core is preheated at 250° C. for 20 min, then immersed in vibrating resin powder, for a prescribed time that depends on a desired thickness of coating and size of the bare magnetic core. The core is thereafter naturally air cooled.

The optimum magnetic core assembly (100) as per present invention is deployable in all applications of flux concentrators and shields; and is particularly deployable in automobiles due to its precision and robustness.

01. An optimum open magnetic core assembly (100) characterized by:
a primary magnetic alloy (101) and at least one supplementing magnetic alloy (102), made of a magnetic material (90) pre-coated with an electrically insulating layer (90C);
wherein the optimum open magnetic core assembly (100) is made of a plurality of laminated magnetic core (110);
wherein the optimum magnetic core assembly (100) has a pair of ends of a laminated magnetic core (110), each of the pair of ends of the optimum magnetic core assembly (100) being one of a co-facing (111) and a flat (113), or a co-facing (111) and a contoured (114), or a co-planer (112) and a flat (113), or a co-planer (112) and a contoured (114); and
wherein a process of producing the optimum magnetic core assembly (100) is one of a wrapping based process ONE (30) or a stamping based process TWO (40) followed by a magnetic performance treatment (50),
wherein the process of producing the optimum magnetic core assembly is governed by the pair of ends of the laminated magnetic core,
wherein the process of producing the optimum magnetic core assembly is decided based on a plurality of inputs on application of the optimum magnetic core assembly (100) and a level ONE of specifications,
wherein the level ONE of specifications includes a magnetic material, a lamination thickness, a hardness, a lamination shape, a shape of pole, and a core dimension.

02. The optimum open magnetic core assembly (100) as claimed in claim 01, wherein the optimum core assembly (100) has a stacking factor of 96 to 99%.

03. The optimum open magnetic core assembly (100) as claimed in claim 01, wherein the magnetic material (90) has an initial hardness of 420 to 480 HV (on Vickers scale).

04. The optimum open magnetic core assembly (100) as claimed in claim 01, wherein the electrically insulating layer (90C) flows onto a sheared edge and a sheared surface (89) of the magnetic material (90).

05. The optimum open magnetic core assembly (100) as claimed in claim 01, wherein the process ONE (30) comprises the steps of:
a. Entrapping a start edge (62) of a roll of a sheet of a selected magnetic material (90) of the primary magnetic alloy (101), by folding and lockingly engaged with a slot (63) in a mandrel (64),
b. Pulling the sheet of the selected magnetic material by a tensile force Ft (65) while the mandrel (64) is rotating,
c. Applying a compressive force Fc (66) intermittently by momentarily stopping the mandrel (64) in an orthogonal plane (67),
d. Slitting the sheet on achieving a requisite width (68) of a thus wound core (91),
e. Disposing permanently a last edge of the sheet on the wound core (91),
f. Dismounting the wound core (91) by sliding the wound core (91) out of the slot (63) in the mandrel (64),
g. Passing the wound core (91) through a correction fixture (31),
h. Repeating the above steps with the supplementing magnetic alloy (102),
i. Inserting interferingly a corrected wound core (92S) of the supplementing magnetic alloy in a corrected wound core (92) of the primary magnetic alloy to arrive at a hybrid corrected core (93),
j. Slitting and slicing the hybrid corrected core (93) to obtain a bare magnetic core assembly (94),
k. Growing grains of the bare magnetic core assembly (94),
l. Vacuum impregnating the bare magnetic core assembly (94),
m. Encasing a treated magnetic core assembly (95) in a non-magnetic resin or a non-magnetic engineering plastic body.

06. The optimum open magnetic core assembly (100) as claimed in claim 05, wherein the entrapping the start edge (62) is by engaging a plurality of orifices (71), with a plurality of spring-loaded pin (72) disposed in a second mandrel (64S).

07. The optimum open magnetic core assembly (100) as claimed in claim 05, wherein the dismounting of the wound core (91) from the second mandrel (64S) is by pulling back the plurality of spring-loaded pins (72).

08. The optimum open magnetic core assembly (100) as claimed in claim 05, wherein the tensile force Ft (65) is lower than a tensile strength of the sheet of the magnetic material (90).

09. The optimum open magnetic core assembly (100) as claimed in claim 05, wherein the corrected wound core (92S) of the supplementing magnetic alloy has an external width (81S) and an external height (82S) tending to be equal to an internal width (81) and an internal height (82) of the corrected core (92) of the primary magnetic alloy.

10. The optimum open magnetic core assembly (100) as claimed in claim 01, wherein the process TWO (40) comprises the steps of:
(i) Producing a required number of primary stampings (53) of the primary magnetic alloy and a required number of supplementary stampings (53B),
(ii) Stacking the primary stampings (53) and the supplementary stampings (53B),
(iii) Compressing the primary stampings (53) and the supplementary stampings (53B) and inseparably attaching to one another through a joining means provided on each stamping, to obtain the bare optimum magnetic core (94S),
(iv) Growing a grains of the bare optimum magnetic core assembly (94S),
(v) Vacuum impregnating the bare optimum magnetic core assembly (94S),
(vi) Encasing a treated optimum magnetic core assembly (95) in a non-magnetic resin or a non-magnetic engineering plastic body.

11. The optimum open magnetic core assembly (100) as claimed in claim 10, wherein the joining means is a plurality of partially displaced projections (54).

12. The optimum open magnetic core assembly (100) as claimed in claim 01, wherein the plurality of magnetic laminations (110) are an interlaced laminations (70) of the primary magnetic alloy (101) and supplementary magnetic alloy (102).

13. The optimum open magnetic core assembly (100) as claimed in claim 01, wherein the plurality of magnetic laminations (110) are a stacking of the required number of stampings of the primary magnetic alloy (101) and the supplementing magnetic alloy (102) in at least a single group of each.

14. The optimum open magnetic core assembly (100) as claimed in claim 05, wherein the treated magnetic core assembly (95) is provided with a resin coating (58), the treated magnetic core assembly (95) is preheated at 250° C. for 20 min, then immersed in a vibrating resin powder, for a prescribed time depending on a desired thickness of coating and a size of the treated optimum magnetic core.
